(19) United States
(12) Patent Application Publication
(10) Pub. No.: US 2021/0178298 A1
(43) Pub. Date: Jun. 17, 2021

(54) LIQUID FILTER

(71) Applicant: A.L. FILTER EAD, Ruse (BG)

(72) Inventors: Plamen KOLEV IVANOV, Ruse (BG); Yaakov BEN SHIMON, Rehovot (IL)

(73) Assignee: A.L. FILTER EAD, Ruse (BG)

(21) Appl. No.: 16/867,986

(22) Filed: May 6, 2020

Related U.S. Application Data
(60) Provisional application No. 62/946,779, filed on Dec. 11, 2019.

(51) Int. Cl. B01D 35/30

(52) U.S. Cl. CPC B01D 35/30; B01D 2201/304; B01D 2201/307

(57) ABSTRACT

A filter element for use with a filter assembly having a filter housing and a rotationally releasable locking mechanism, the filter element including first and second end plates, the second end plate having a central aperture, a filtering medium arranged between the first and second end plates in a generally hollow cylindrical configuration about a central bore arranged about an axis, the central bore communicating with the central aperture in the second end plate, at least one perforated cylindrical pipe located in the central bore and a locking mechanism rotating assembly, sealingly extending through the central aperture of the second end plate and having a seal mounted thereon, for sealing the filter element in the filter housing.

### REFERENCE TO RELATED APPLICATIONS

Reference is made to U.S. Provisional Patent Application Ser. No. 62/946,779 filed Dec. 11, 2019 and entitled LIQUID FILTER, the disclosure of which is hereby incorporated by reference and priority of which is claimed.

### FIELD OF THE INVENTION

The present invention relates to fluid filters, generally, and more particularly to fluid filters useful in motor vehicles.

### BACKGROUND OF THE INVENTION

Various types of fluid filters and filter assemblies are known in the patent literature. U.S. Patent Publication Nos. 2019/030466; 2019/030469 and 2018/326332 and U.S. Pat. Nos. 9,044,698; 9,393,506; 10,456,719 and 9,023,203 describes relevant filter assemblies.

### SUMMARY OF THE INVENTION

The present invention seeks to provide a fluid filter element which is suitable for use with elements of the filter system described in U.S. Pat. No. 9,044,698.

There is thus provided in accordance with a preferred embodiment of the present invention a filter element for use with a filter assembly having a filter housing and a rotationally releasable locking mechanism, the filter element including first and second end plates, the second end plate having a central aperture, a filtering medium arranged between the first and second end plates in a generally hollow cylindrical configuration about a central bore arranged about an axis, the central bore communicating with the central aperture in the second end plate, at least one perforated cylindrical pipe located in the central bore and a locking mechanism rotating assembly, sealingly extending through the central aperture of the second end plate and having a seal mounted thereon, for sealing the filter element in the filter housing.

Preferably, the locking mechanism rotating assembly is integrally formed with one of the at least one perforated cylindrical pipe. Alternatively, the locking mechanism rotating assembly is separate from and mounted onto one of the at least one perforated cylindrical pipe.

In accordance with a preferred embodiment of the present invention the locking mechanism rotating assembly includes at least one protrusion for rotational driving engagement with the rotationally releasable locking mechanism. Alternatively, the locking mechanism rotating assembly includes a frictional engagement surface for frictional engagement with the rotationally releasable locking mechanism, whereby rotation of the filter element in engagement with the locking mechanism about the axis, frictionally drives rotation of the locking mechanism about the axis.

Preferably, the locking mechanism rotating assembly sealingly engages the central aperture of the second end plate by means of a circumferential seal extending along a periphery of the central aperture.

In accordance with an embodiment of the present invention the locking mechanism rotating assembly is mounted onto the at least one perforated cylindrical pipe by a snap fit mounting.

### BRIEF DESCRIPTION OF THE DRAWINGS

The present invention will be understood and appreciated more fully from the following detailed description, taken in conjunction with the drawings in which:

FIG. 1A is a simplified pictorial illustration of a filter element constructed and operative in accordance with a preferred embodiment of the present invention;

FIG. 1B is a simplified sectional illustration of the filter element of FIG. 1A, taken along the lines B-B in FIG. 1A; including an enlargement;

FIG. 1C is a simplified exploded view illustration of the filter element of FIGS. 1A and 1B;

FIG. 1D is a simplified pictorial illustration of an integrally formed perforated cylindrical pipe and locking mechanism rotating assembly forming part of the filter element of FIGS. 1A-1C;

FIG. 1E is a simplified sectional illustration of the perforated cylindrical pipe and locking mechanism rotating assembly, corresponding to FIG. 1D and taken along lines E-E therein;

FIG. 1F is a simplified pictorial illustration of the perforated cylindrical pipe and locking mechanism rotating assembly, taken in a direction indicated by an arrow F, appearing in FIG. 1D;

FIG. 2A is a simplified pictorial illustration of a filter element constructed and operative in accordance with another preferred embodiment of the present invention;

FIG. 2B is a simplified sectional illustration of the filter element of FIG. 2A, taken along the lines B-B in FIG. 2A, including an enlargement;

FIG. 2C is a simplified exploded view illustration of the filter element of FIGS. 2A and 2B;

FIG. 2D is a simplified pictorial illustration of a perforated cylindrical pipe and a locking mechanism rotating assembly prior to assembly thereof;

FIG. 2E is a simplified sectional illustration of a perforated cylindrical pipe and a locking mechanism rotating assembly prior to assembly thereof, corresponding to FIG. 2D and taken along lines EE therein;

FIG. 2F is a simplified pictorial illustration of a perforated cylindrical pipe and a locking mechanism rotating assembly following snap fit assembly thereof;

FIG. 2G is a simplified sectional illustration of a perforated cylindrical pipe and a locking mechanism rotating assembly following snap fit assembly thereof, corresponding to FIG. 2F and taken along lines G-G therein;

FIG. 2H is a simplified pictorial illustration of the perforated cylindrical pipe and locking mechanism rotating assembly, taken in a direction indicated by an arrow H, appearing in FIG. 2F;

FIG. 3A is a simplified pictorial illustration of a filter element constructed and operative in accordance with yet another preferred embodiment of the present invention;

FIG. 3B is a simplified sectional illustration of the filter element of FIG. 3A, taken along the lines B-B in FIG. 3A, including an enlargement;

FIG. 3C is a simplified exploded view illustration of the filter element of FIGS. 3A and 3B;

FIG. 3D is a simplified pictorial illustration of a perforated cylindrical pipe and a locking mechanism rotating assembly forming part of the filter element of FIGS. 3A-3C, prior to assembly thereof;

FIG. 3E is a simplified sectional illustration of a perforated cylindrical pipe and a locking mechanism rotating assembly forming part of the filter element of FIGS. 3A-3C, prior to assembly thereof, corresponding to FIG. 3D and taken along lines E-E therein;

FIG. 3F is a simplified pictorial illustration of a perforated cylindrical pipe and a locking mechanism rotating assembly forming part of the filter element of FIGS. 3A-3C, following snap fit assembly thereof; and

FIG. 3G is a simplified sectional illustration of a perforated cylindrical pipe and a locking mechanism rotating assembly forming part of the filter element of FIGS. 3A-3C, following snap fit assembly thereof, corresponding to FIG. 3F and taken along lines G-G therein.

### DETAILED DESCRIPTION OF PREFERRED EMBODIMENTS

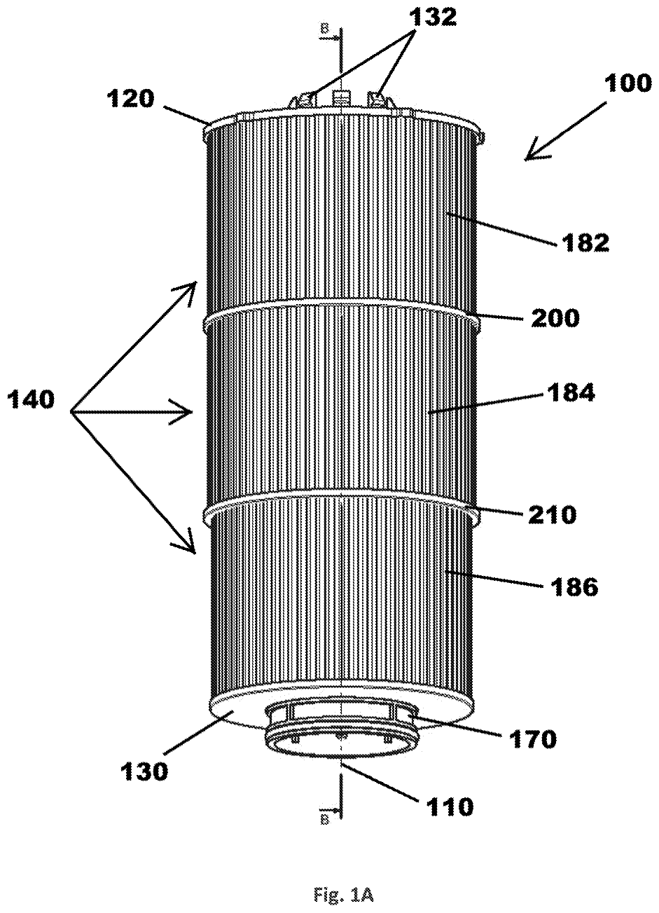

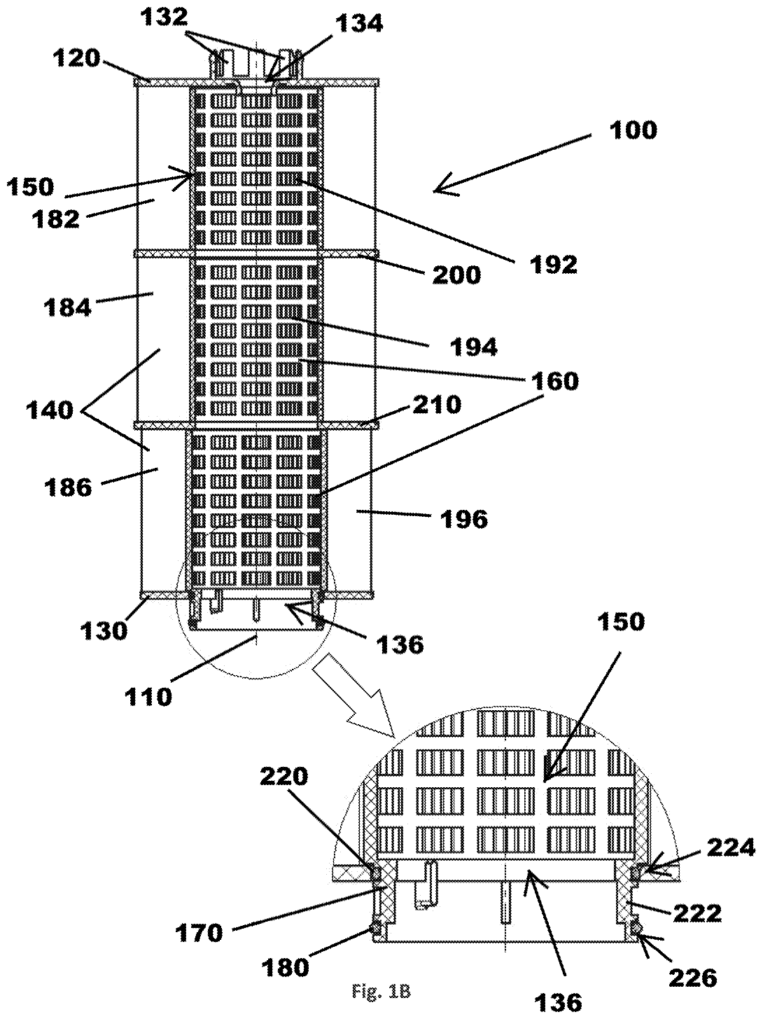

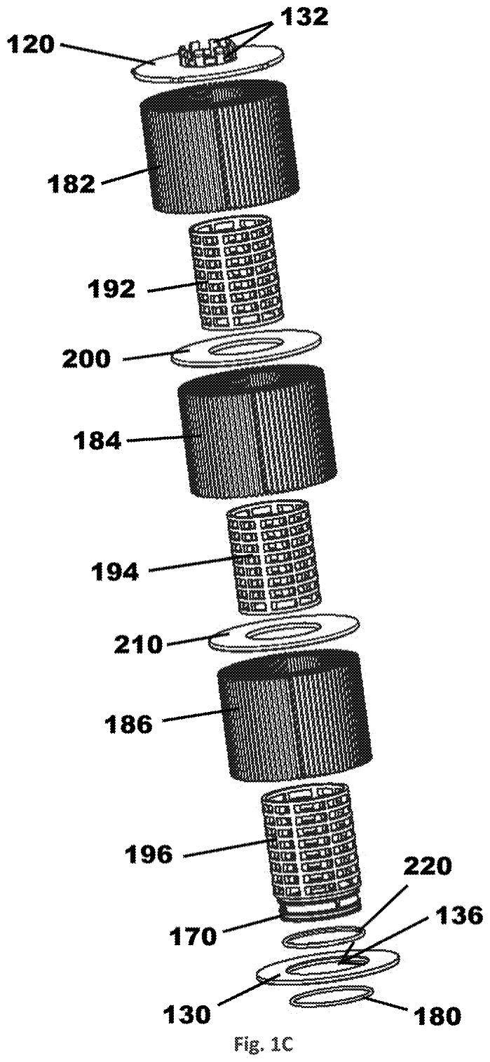

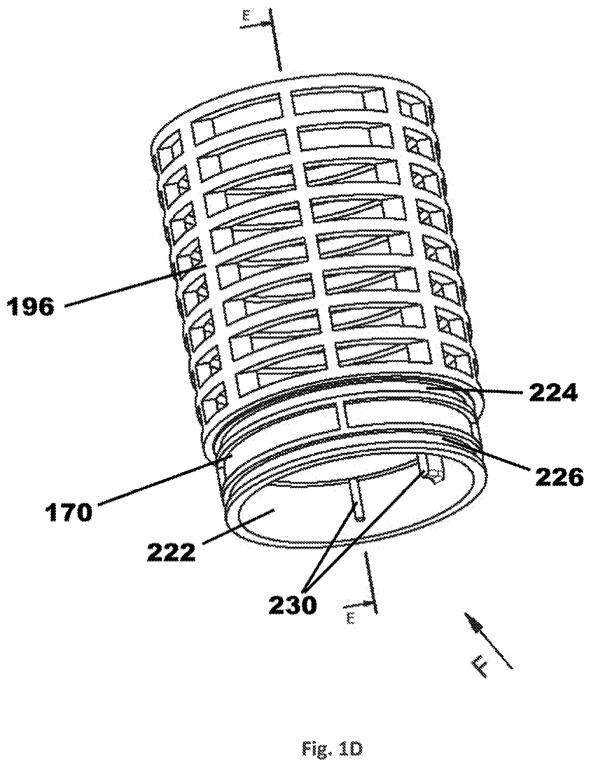

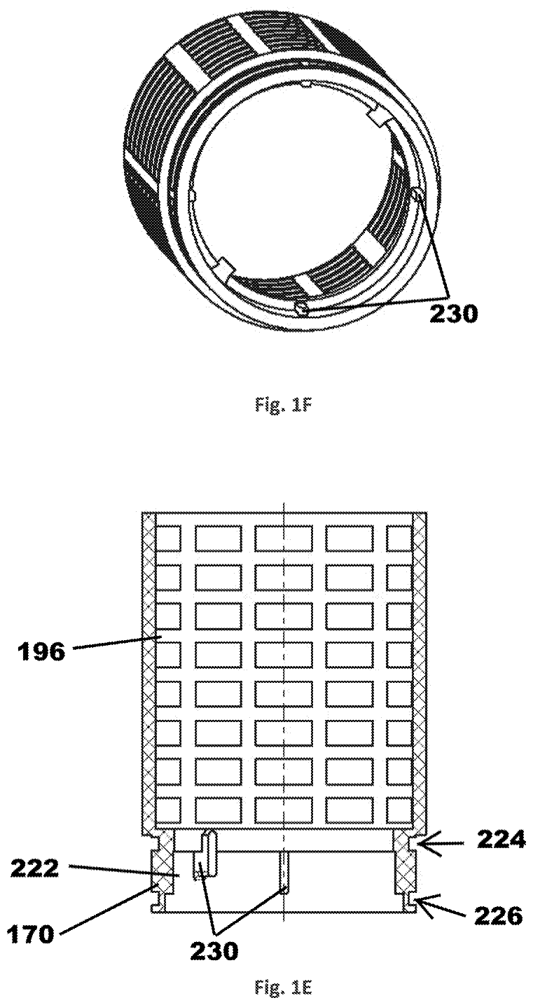

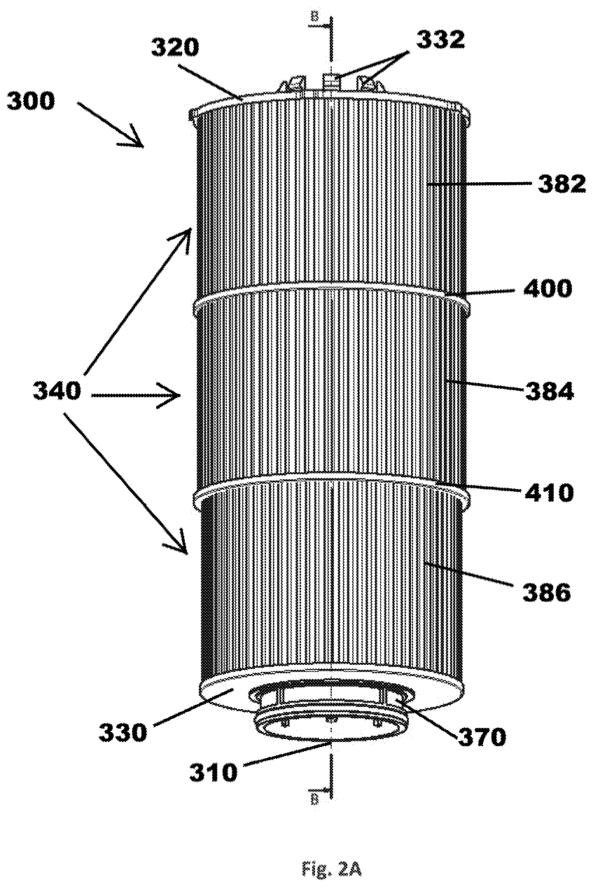

Reference is now made to FIGS. 1A-1F, which illustrate a filter element 100 constructed and operative in accordance with a preferred embodiment of the present invention.

As seen in FIGS. 1A-1F, the filter element 100 is of generally cylindrical configuration and is arranged about an axis 110 and comprises first and second end plates, respectively designated by reference numerals 120 and 130. The first end plate 120 is formed with a generally circular army of snap fit protrusions 132 and is formed with a first central aperture 134 and the second end plate 130 is formed with a second central aperture 136, larger than the first central aperture 134.

A filtering medium, indicated generally by reference numeral 140, is arranged in an accordion-like circular arrangement between the first and second end plates 120 and 130 in a generally hollow cylindrical configuration about a central bore 150 centered on axis 110. The central bore 150 communicates with central aperture 136 formed in second end plate 130. At least one perforated cylindrical pipe, indicated generally by reference numeral 160, is located in central bore 150 interiorly of the filtering medium 140.

It is a particular feature of an embodiment of the present invention that a locking mechanism rotating assembly, generally designated by reference numeral 170, sealingly extends through central aperture 136 of the second end plate and has a seal 180 mounted thereon, for sealing the Filter element to a filter housing, not shown, such as the filter housing described in U.S. Pat. No. 9,044,698.

In the illustrated embodiment of the present invention shown in FIGS. 1A -1F, the filtering medium 140 comprises three separate cylindrical arrangements of filtering medium, here designated by reference numerals 182, 184 and 186, and the at least one perforated cylindrical pipe 160 comprises three separate perforated cylindrical pipe segments, here designated by reference numerals 192, 194 and 196.

In the illustrated embodiment of the present invention shown in FIGS. 1A -1F, filtering medium 182 is adhered, as by heat welding, to an interior planar surface of first end plate 120. Perforated cylindrical pipe segment 192 is press fitted within the filtering medium 182. Filtering medium 182 is also joined to a first planar surface of a first intermediate aperture disk 200, as by heat welding, In this embodiment, filtering medium 184 is adhered, as by heat welding, to a second planar surface of intermediate aperture disk 200. Perforated cylindrical pipe segment 194 is press fitted within the filtering medium 184. Filtering medium 184 is also joined to a first surface of a second intermediate aperture disk 210, as by heat welding. Also In this embodiment, filtering medium 186 is adhered, as by heat welding, to a second planar surface of second intermediate aperture disk 210. Perforated cylindrical pipe segment 196 is press fitted within the filtering medium 186. Filtering medium 196 is also joined to an inner planar surface of second end plate 130, as by heat welding.

It is a particular feature of the illustrated embodiment of FIGS 1A-1F that locking mechanism rotating assembly 170 is integrally formed as one piece with perforated cylindrical pipe segment 196 and sealingly extends through central aperture 136 of the second end plate 130 via a peripheral seal 220. Locking mechanism rotating assembly 170 comprises a generally cylindrical body portion 222 preferably formed with recesses 224 and 226 for mounting thereon of seals 220 and 180 respectively.

It is also a particular feature of the illustrated embodiment of FIGS. 1A-1F that locking mechanism rotating assembly 170 is formed with a plurality of locking mechanism engagement protrusions 230, shown particularly in FIG. 1F, which are configured for operative engagement with rotational driving cams in a locking mechanism, such as the locking mechanism described in U.S. Pat. No. 9,044,698.

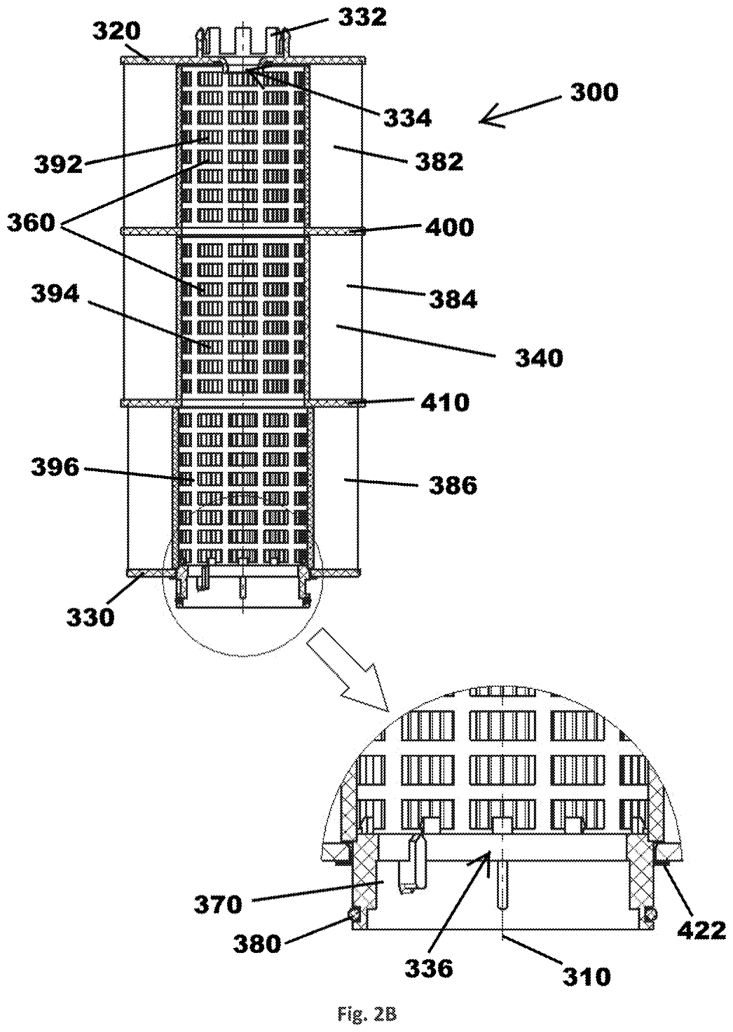

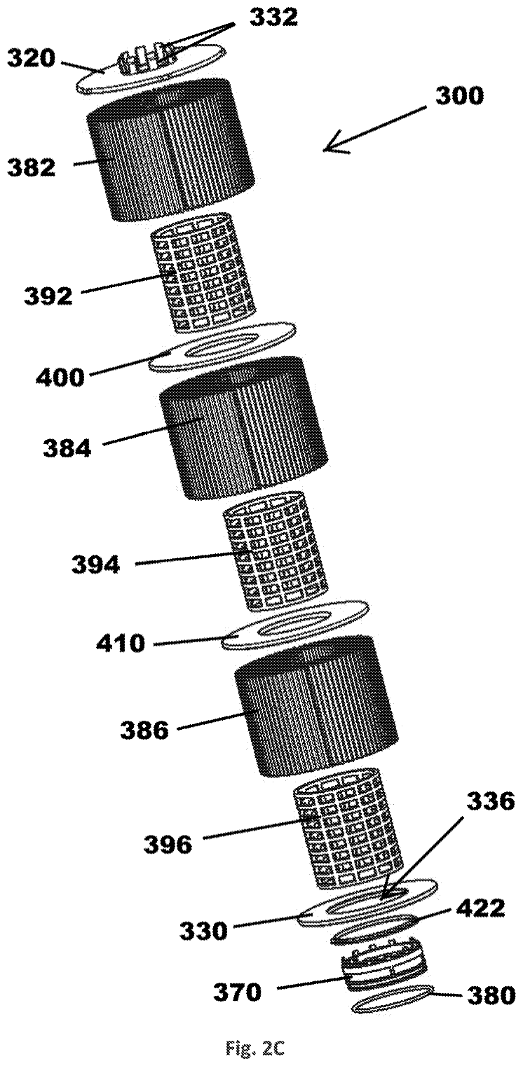

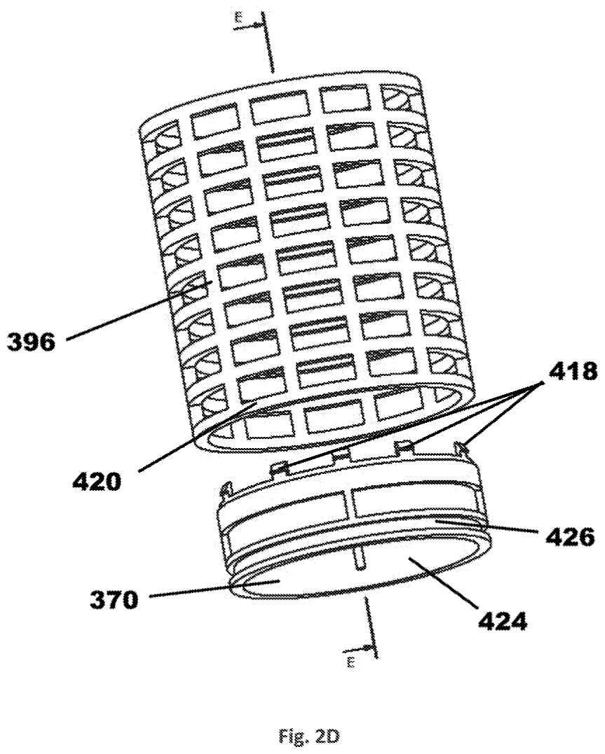

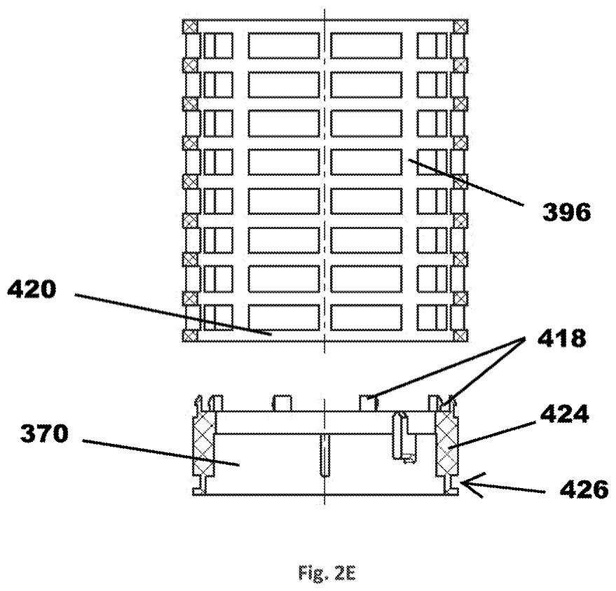

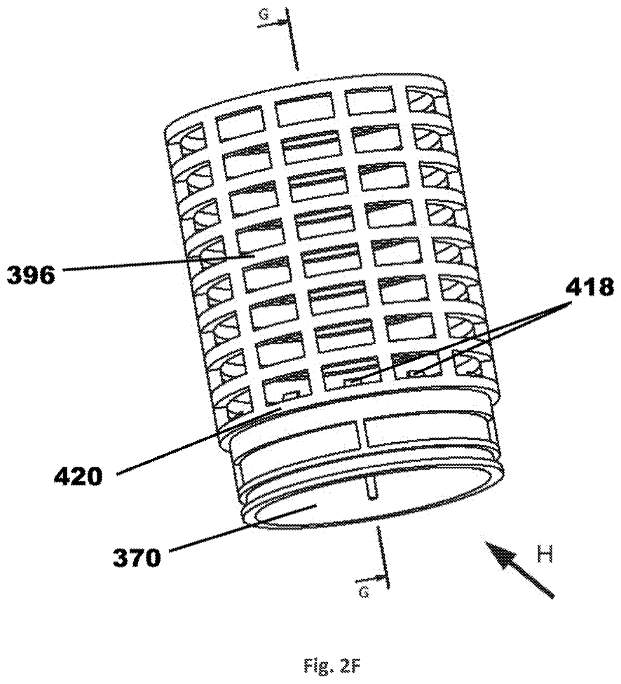

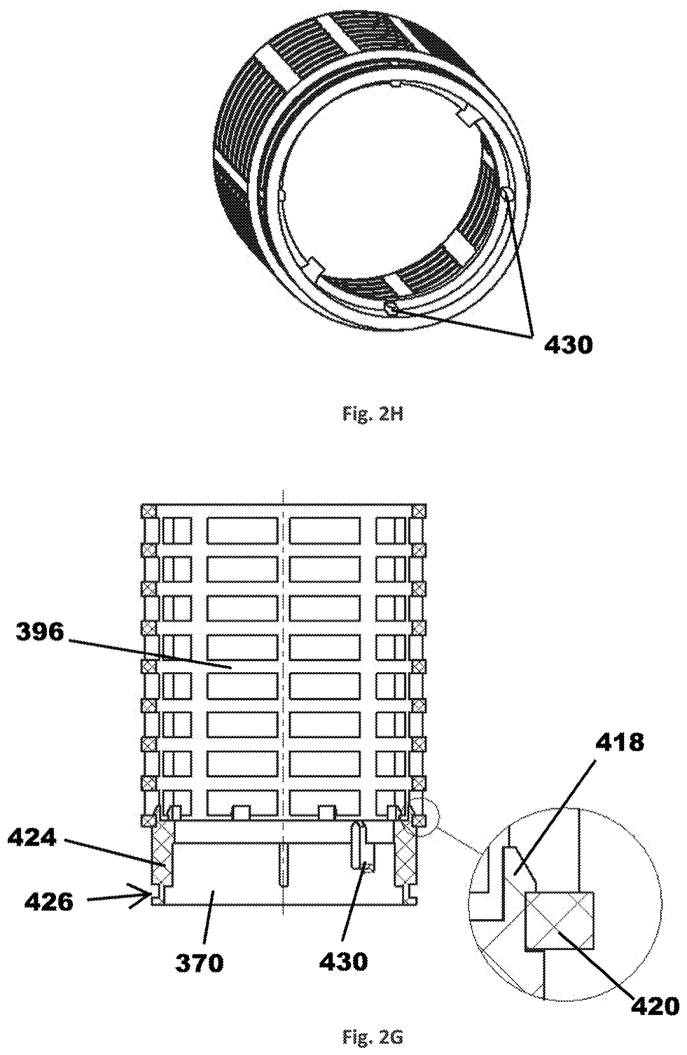

Reference is now made to FIGS. 2A-2H, which illustrate a filter element 300 constructed and operative in accordance with another preferred embodiment of the present invention.

As seen in FIGS. 2A-2H, the filter element 300 is of generally cylindrical configuration and is arranged about an axis 310 and comprises first and second end plates, respectively designated by reference numerals 320 and 330. The first end plate 320 is formed with a generally circular array of snap fit protrusions 332 and is formed with a first central aperture 334 and the second end plate 330 is formed with a second central aperture 336, larger than the first central aperture.

A filtering medium, indicated generally by reference numeral 340, is arranged in an accordion-like circular arrangement between the first and second end plates 320 and 330 in a generally hollow cylindrical configuration about a central bore 350 centered on axis 310. The central bore 350 communicates with central aperture 336 formed in second end plate 330. At least one perforated cylindrical pipe, indicated generally by reference numeral 360, is located in central bore 350 interiorly of the filtering medium 340.

It is a particular feature of an embodiment of the present invention that a locking mechanism rotating assembly, generally designated by reference numeral 370, sealingly extends through central aperture 336 of the second end plate and has a seal 380 mounted thereon, for sealing the filter element to a filter housing, not shown, such as the filter housing described in U.S. Pat. No. 9,044,698.

In the illustrated embodiment of the present invention shown in FIGS. 2A -2H, the filtering medium 340 comprises three separate cylindrical arrangements of filtering medium, here designated by reference numerals 382, 384 and 386, and the at least one perforated cylindrical pipe 360 comprises three separate perforated cylindrical pipe segments, here designated by reference numerals 392, 394 and 396.

In the illustrated embodiment of the present invention shown in FIGS. 2A -2H, filtering medium 382 is adhered, as by heat welding, to an interior planar surface of first end plate 320. Perforated cylindrical pipe segment 392 is press fitted within the filtering medium 382. Filtering, medium 382 is also joined to a first planar surface of a first intermediate aperture disk 400, as by heat welding. In this embodiment, filtering medium 384 is adhered, as by heat welding, to a second planar surface of intermediate aperture disk 400. Perforated cylindrical pipe segment 394 is press fitted within the filtering medium 384. Filtering medium 384 is also joined to a first surface of a second intermediate aperture disk 410, as by heat welding. Also In this embodiment, filtering medium 386 is adhered, as by heat welding, to a second planar surface of second intermediate aperture disk 410. Perforated cylindrical pipe segment 396 is press fitted within the filtering medium 386. Filtering medium 396 is also joined to an inner planar surface of second end plate 340, as by heat welding.

It is a particular feature of the illustrated embodiment of FIGS. 2A-2H that, as distinct from the embodiment of FIGS. 1A-1F, in this embodiment locking mechanism rotating assembly 370 is not integrally formed as one piece with perforated cylindrical pipe segment 396 but rather is a separate element and is snap fit mounted onto perforated cylindrical pipe segment 396 as by means of snap protrusions 418, which engage a circumferential rib 420 of perforated cylindrical pipe segment 396. Locking mechanism rotating assembly 370 sealingly extends through central aperture 336 of the second end plate 330 via a peripheral seal 422, which is preferably ultrasonically welded onto the second end plate 330 about an inner-facing edge of central aperture 336. Locking mechanism rotating assembly 370 comprises a generally cylindrical body portion 424 preferably formed with a recess 426 for mounting thereon of seal 380.

Is also a particular feature of the illustrated embodiment of FIGS. 2A-2H that locking mechanism rotating assembly 370 is formed with a plurality of locking mechanism engagement protrusions 430, which are configured for operative engagement with rotational driving cams in a locking mechanism, such as the locking mechanism described in U.S. Pat. No. 9,044,698,

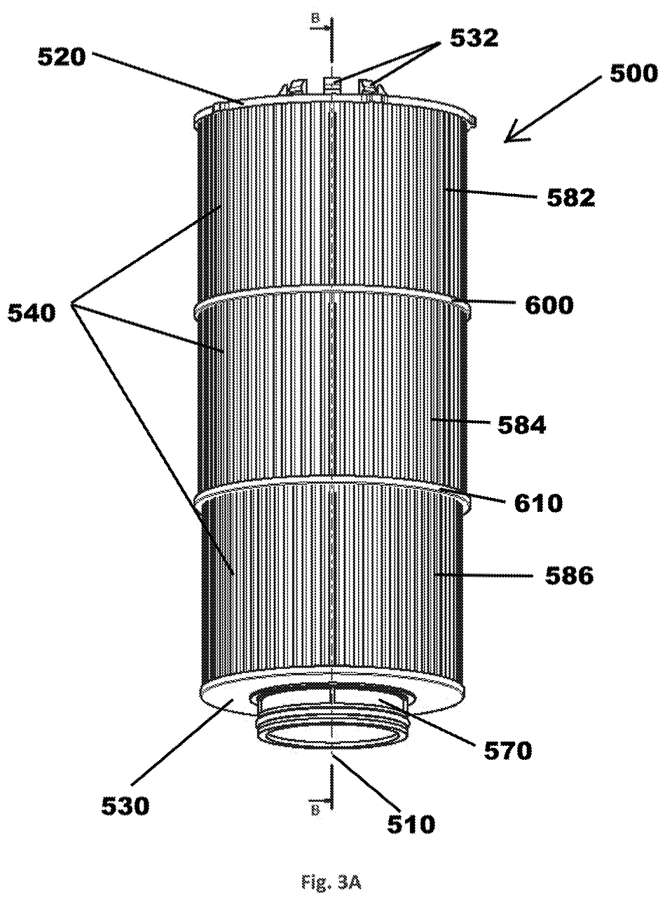

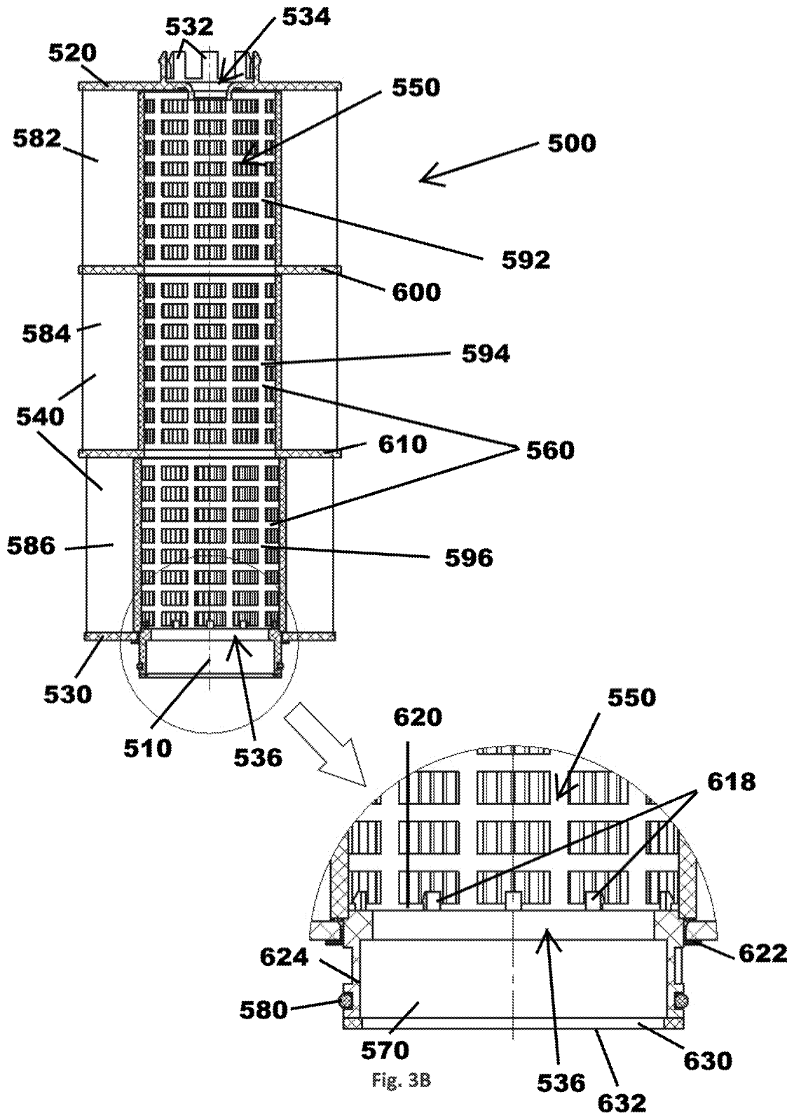

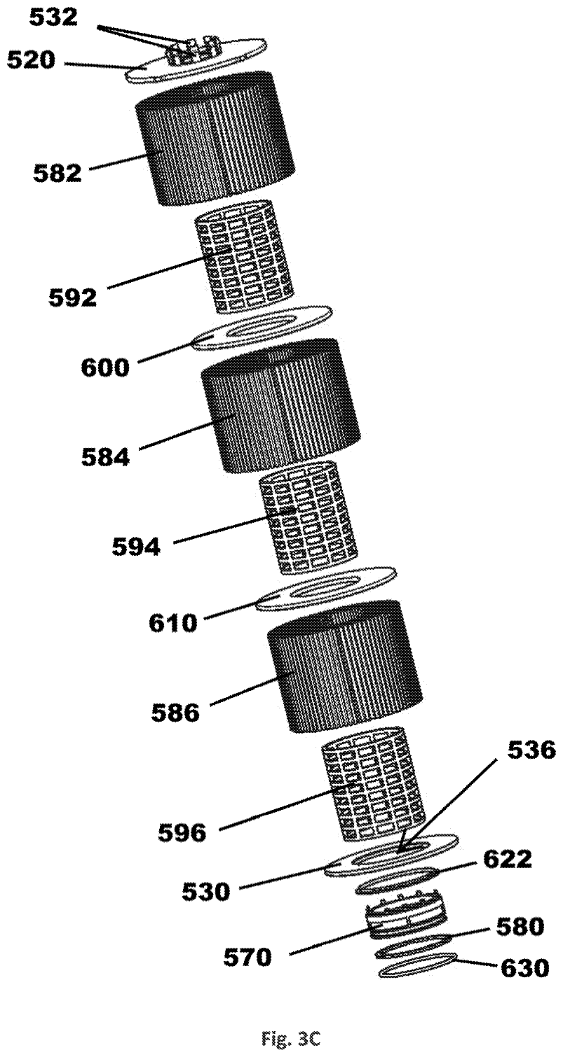

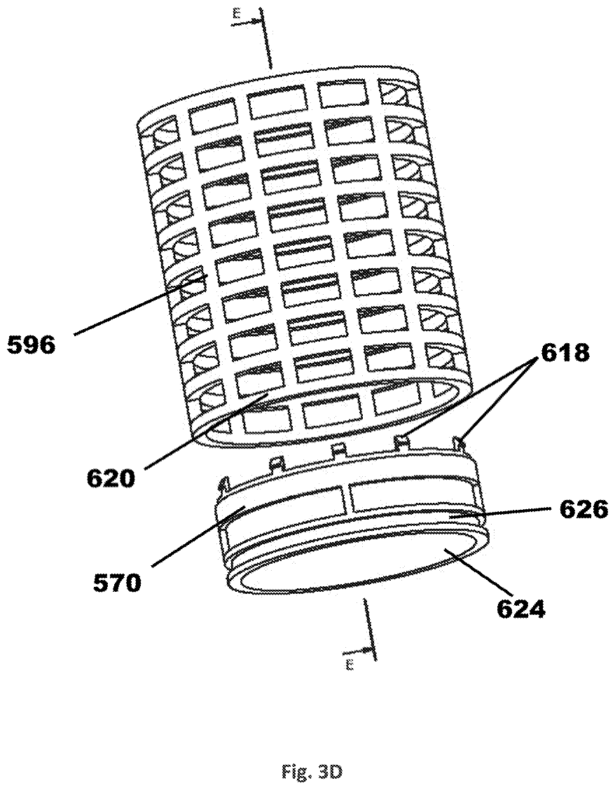

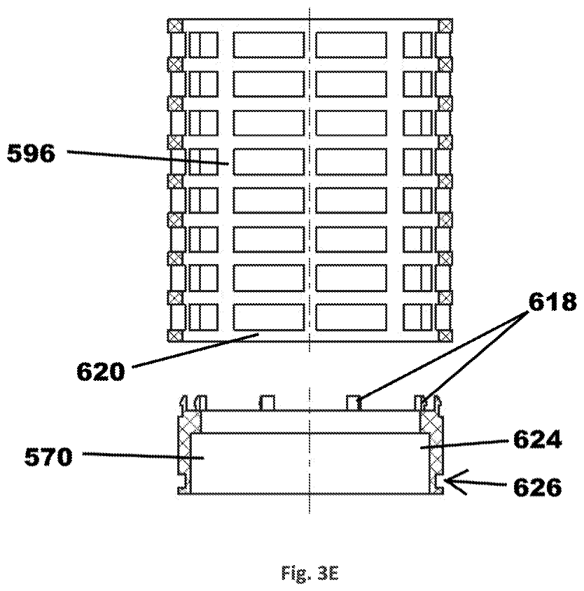

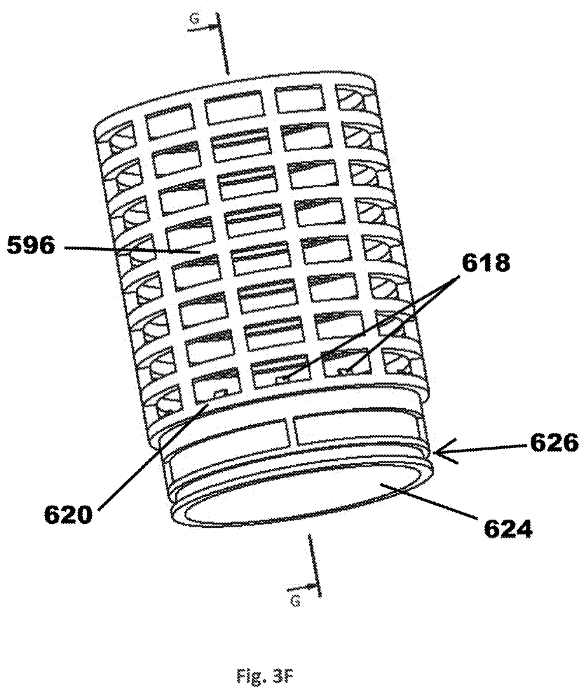

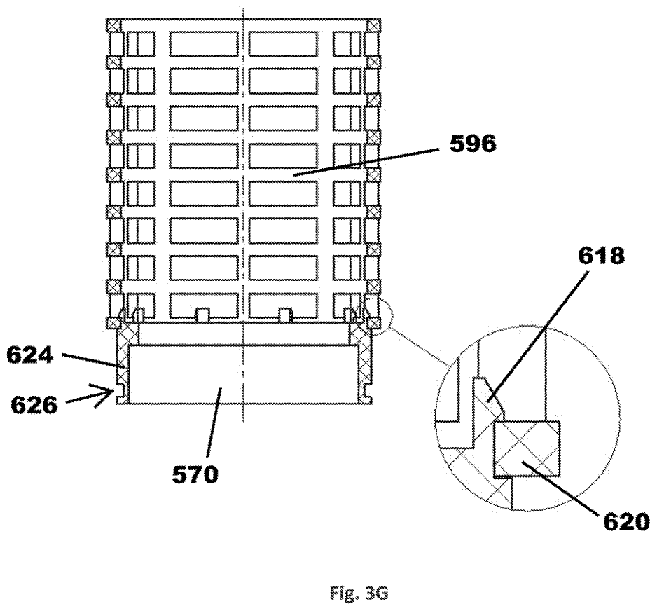

Reference is now made to FIGS. 3A-3G, which illustrate a filter element 500 constructed and operative in accordance with yet another preferred embodiment of the present invention.

As seen in FIGS. 3A-3G, the filter element 500 is of generally cylindrical configuration and is arranged about an axis 510 and comprises first and second end plates, respectively designated by reference numerals 520 and 530. The first end plate 520 is formed with a generally circular array of snap fit protrusions 532 and is formed with a first central aperture 534 and the second end plate 530 is formed with a second central aperture 536, larger than the first central aperture.

A filtering medium, indicated generally by reference numeral 540, is arranged in an accordion-like circular arrangement between the first and second end plates 520 and 530 in a generally hollow cylindrical configuration about a central bore 550 centered on axis 510. The central bore 550 communicates with central aperture 536 formed in second end plate 530. At least one perforated cylindrical pipe, indicated generally by reference numeral 560, is located in central bore 550 interiorly of the filtering medium 540.

It is a particular feature of an embodiment of the present invention that a locking mechanism rotating assembly, generally designated by reference numeral 570, sealingly extends through central aperture 534 of the second end plate and has a seal 580 mounted thereon, for sealing the filter element to a filter housing, not shown, such as the filter housing described in U.S. Pat. No. 9,044,698.

In the illustrated embodiment of the present invention shown in FIGS. 3A -3G, the filtering medium 540 comprises three separate cylindrical arrangements of filtering medium, here designated by reference numerals 582, 584 and 586, and the at least one perforated cylindrical pipe 560 comprises three separate perforated cylindrical pipe segments, here designated by reference numerals 592, 594 and 596,

In the illustrated embodiment of the present invention shown in FIGS. 3A -3G, filtering medium 582 is adhered, as by heat welding, to an interior planar surface of first end plate 520. Perforated cylindrical pipe segment 592 is press fitted within the filtering medium 582. Filtering medium 582 is also joined to a first planar surface of a first intermediate aperture disk 600, as by heat welding. In this embodiment, filtering medium 584 is adhered, as by heat welding, to a second planar surface of intermediate aperture disk 600. Perforated cylindrical pipe segment 594 is press fitted within the filtering medium 584. Filtering medium 584 is also joined to a first surface of a second intermediate aperture disk 610, as by heat welding. Also, in this embodiment, filtering medium 586 is adhered, as by heat welding, to a second planar surface of second intermediate aperture disk 610. Perforated cylindrical pipe segment 596 is press fitted within the filtering medium 586. Filtering medium 596 is also joined to an inner planar surface of second end plate 540, as by heat welding.

It is a particular feature of the illustrated embodiment of FIGS. 3A-3G that, as distinct from the embodiment of FIGS. 1A-1E, in this embodiment locking mechanism rotating assembly 570 is not integrally formed as one piece with perforated cylindrical pipe segment 596 but rather is a separate element and is snap fit mounted onto perforated cylindrical pipe segment 596 by means of snap protrusions 618, which engage a circumferential rib 620 of perforated cylindrical pipe segment 596. Locking mechanism rotating assembly 570 sealingly extends through central aperture 536 of the second end plate 530 via a peripheral seal 622, which is preferably ultrasonically welded onto the second end plate 530 about an inner-facing edge of central aperture 536. Locking mechanism rotating assembly 370 comprises a generally cylindrical body portion 624 preferably formed with a recess 626 for mounting thereon of seal 580.

It is also a particular feature of the illustrated embodiment of FIGS. 3A-3G that, as distinct from the embodiments of FIGS. 1A-1F and 2A-2H, locking mechanism rotating assembly 570 is not formed with a plurality of locking mechanism engagement protrusions, which are configured for operative engagement with rotational driving cams in a locking mechanism, such as the locking mechanism described in U.S. Pat. No. 9,044,698. Instead, there is adhered, as by ultrasonic welding or by use of an adhesive, to a bottom surface of locking mechanism rotating assembly 570, a felt disk 630, which provides a frictional engagement surface 632 for frictional engagement with a rotationally releasable locking mechanism, such as the locking mechanism described in U.S. Pat. No. 9,044,698, whereby rotation of the filter element 500 in engagement with the locking mechanism, about axis 510, frictionally drives rotation of the locking mechanism about axis 510.

It will be appreciated by persons skilled in the art that the present invention is not limited by what has been particularly shown and described hereinabove. Rather the scope of the invention includes combinations and subcombinations of the various novel features described hereinabove as well as equivalents thereof, which are not in the prior art.

1. A filter element for use with a filter assembly having a filter housing and a rotationally releasable locking mechanism, the filter element comprising:
first and second end plates, said second end plate having a central aperture;
a filtering medium arranged between said first and second end plates in a generally hollow cylindrical configuration about a central bore arranged about an axis, said central bore communicating with said central aperture in said second end plate;
at least one perforated cylindrical pipe located in said central bore; and
a locking mechanism rotating assembly, sealingly extending through said central aperture of said second end plate and having a seal mounted thereon, for sealing said filter element in said filter housing.

2. A filter element according to claim 1 and wherein said locking mechanism rotating assembly is integrally formed with one of said at least one perforated cylindrical pipe.

3. A filter element according to claim 2 and wherein said locking mechanism rotating assembly includes at least one protrusion tier rotational driving engagement with said rotationally releasable locking mechanism.

4. A filter element according to claim 3 and wherein said locking mechanism rotating assembly sealingly engages said central aperture of said second end plate by means of a circumferential seal extending along a periphery of said central aperture.

5. A filter element according to claim 2 and wherein said locking mechanism rotating assembly includes a frictional engagement surface for frictional engagement with said rotationally releasable locking mechanism, whereby rotation of said filter element in engagement with said locking mechanism about said axis, frictionally drives rotation of said locking mechanism about said axis.

6. A filter element according to claim 5 and wherein said locking mechanism rotating assembly sealingly engages said central aperture of said second end plate by means of a circumferential seal extending along a periphery of said central aperture.

7. A filter element according to claim 2 and wherein said locking mechanism rotating assembly sealingly engages said central aperture of said second end plate by means of a circumferential seal extending along a periphery of said central aperture.

8. A filter element according to claim 1 and wherein said locking mechanism rotating assembly is separate from and mounted onto one of said at least one perforated cylindrical pipe.

9. A filter element according to claim 8 and wherein said locking mechanism rotating assembly includes at least one protrusion for rotational driving engagement with said rotationally releasable locking mechanism.

10. A filter element according to claim 9 and wherein said locking mechanism rotating assembly sealingly engages said central aperture of said second end plate by means of a circumferential seal extending along a periphery of said central aperture.

11. A filter element according to claim 8 and wherein said locking mechanism rotating assembly includes a frictional engagement surface for frictional engagement with said rotationally releasable locking mechanism, whereby rotation of said filter element in engagement with said locking mechanism about said axis, frictionally drives rotation of said locking mechanism about said axis.

12. A filter element according to claim 11 and wherein said locking mechanism rotating assembly sealingly engages said central aperture of said second end plate by means of a circumferential seal extending along a periphery of said central aperture.

13. A filter element according to claim 8 and wherein said locking mechanism rotating assembly sealingly engages said central aperture of said second end plate by means of a circumferential seal extending along a periphery of said central aperture.

14. A filter element according to claim 8 and wherein said locking mechanism rotating assembly is mounted onto said at least one perforated cylindrical pipe by a snap fit mounting.

15. A filter element according to claim 1 and wherein said locking mechanism rotating assembly sealingly engages said central aperture of said second end plate by means of a circumferential seal extending along a periphery of said central aperture.
